(19) United States
(12) Patent Application Publication
(10) Pub. No.: US 2015/0022739 A1
(43) Pub. Date: Jan. 22, 2015

(54) TOUCH PANEL AND TOUCH DISPLAY PANEL

(71) Applicant: WINTEK CORPORATION, Taichung City (TW)

(72) Inventors: Chien-Chung Chen, Taichung City (TW); Yung-Lin Chen, Changhua County (TW); Hen-Ta Kang, Taichung City (TW)

(21) Appl. No.: 14/333,528

(22) Filed: Jul. 17, 2014

(30) Foreign Application Priority Data
Jul. 17, 2013 (TW) 102125610

(51) Int. Cl. G06F 1/16

(52) U.S. Cl. CPC G06F 1/1643
USPC 349/12

(57) ABSTRACT

The present invention provides a touch panel. The touch panel includes a substrate, a touch sensing device, and an optical matching layer. The touch sensing device is disposed on one side of the substrate, and includes an electrode pattern. The electrode pattern includes silver or silver alloy. At least one side of the substrate has the optical matching layer disposed thereon.

### BACKGROUND OF THE INVENTION

1. Field of the Invention

The present invention relates to a touch panel and a touch display panel, and more particularly, to a touch panel and a touch display panel having uniform light transmittance.

2. Description of the Prior Art

Touch panels have been widely used in various external input devices of electronic equipment, due to the human-machine interaction property thereof. In recent years, as the flourishing development of the consumer electronics, there are many display devices in combination with touch sensing functions, such as mobile phones, GPS navigator system, tablet PCs, personal digital assistants (PDA), and laptop PC.

A conventional touch panel is disposed on the display surface of the display device, so that the picture displayed on the display surface has to be seen by penetrating through the touch panel. Thus, the touch panel has to be made from transparent materials, to keep from interfering with the picture seen by the user. In the conventional touch panel, there is a plurality of transparent electrode patterns disposed on a transparent substrate, and the transparent electrode patterns are configured to detect the position of the touch panel which is being touched by a finger. Wherein, each of the transparent electrode patterns is consisted of a plurality of sensing electrodes and a plurality of connection electrodes, and the sensing electrodes are arranged in an array arrangement. In each of the transparent electrode patterns, each of the connection electrodes connects two sensing electrodes adjacent to each other to form a sensing series, and the sensing series formed by different transparent electrode patterns respectively are perpendicular to each other. Also, in the direction perpendicular to the substrate, the transparent electrode patterns do not completely cover the entire transparent substrate, and there is a gap between any two of the sensing electrodes adjacent to each other in different transparent electrode patterns.

Hence, to provide a touch panel having uniform light transmittance to reduce the visibility of the transparent electrode patterns is still a major objective in the field.

### SUMMARY OF THE INVENTION

It is one of the objectives of the present invention to provide a touch panel and a touch display panel to improve said issues in the prior art.

To achieve the purpose described above, the present invention provides a touch panel, including a substrate, a touch sensing device and an optical matching layer. The touch sensing device is disposed on a side of the substrate, and the touch sensing device includes an electrode pattern. The optical matching layer is disposed on a side of the substrate.

To achieve the purpose described above, the present invention further provides a touch display panel, including a display panel. The display panel includes a substrate, a touch sensing device and an optical matching layer. The touch sensing device is disposed on a side of the substrate, and the touch sensing device includes an electrode pattern. The optical matching layer is disposed on a side of the substrate.

Through disposing the optical matching layer on at least a side of the substrate, the touch panel of the present invention can effectively reduce the color differences and the brightness differences between the portion of the touch panel corresponding to the electrode pattern and the portion of the touch panel corresponding to the gap, so as to obtain uniform light transmittance accordingly. With such, the visibility of the touch sensing device can be significantly reduced, and the touch sensing device is no longer to easily be seen and recognized by the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic top view illustrating a touch panel according to a first embodiment of the present invention.

FIGS. 1B and 1C are schematic top views illustrating different variant types of the touch sensing device according to the first embodiment of the present invention.

FIG. 2 is a schematic cross-sectional view taken along the cross line A-A′ in FIG. 1A.

FIG. 3 is a schematic cross-sectional view illustrating another variant type of the touch panel according to the first embodiment of the present invention.

FIG. 4 is a schematic cross-sectional view illustrating the other variant type of the touch panel according to the first embodiment of the present invention.

FIG. 5 is a schematic cross-sectional view illustrating another variant type of the touch panel according to the first embodiment of the present invention.

FIG. 6 is a schematic cross-sectional view illustrating another variant type of the touch panel according to the first embodiment of the present invention.

FIG. 7 is a schematic cross-sectional view illustrating a touch panel according to a second embodiment of the present invention.

FIG. 8 is a schematic cross-sectional view illustrating a touch panel according to a third embodiment of the present invention.

FIG. 9 is a schematic cross-sectional view illustrating a touch panel according to a fourth embodiment of the present invention.

FIG. 10 is a schematic cross-sectional view illustrating a touch panel according to a fifth embodiment of the present invention.

FIG. 11 is a schematic cross-sectional view illustrating a touch panel according to a sixth embodiment of the present invention.

FIG. 12 is a schematic cross-sectional view illustrating a touch panel according to a seventh embodiment of the present invention.

FIG. 13 is a schematic cross-sectional view taken along the cross line B-B′ in FIG. 12.

FIG. 14 is a schematic top view illustrating the touch display panel according to an eighth embodiment of the present invention.

FIG. 15 is a schematic cross-sectional view illustrating the touch display panel according to the eighth embodiment of the present invention.

FIG. 16 is a schematic cross-sectional view illustrating the touch panel according to a ninth embodiment of the present invention.

FIG. 17 is a schematic cross-sectional view illustrating the touch display panel according to a tenth embodiment of the present invention.

FIG. 18 is a schematic top view illustrating the touch display panel according to an eleventh embodiment of the present invention.

### DETAILED DESCRIPTION

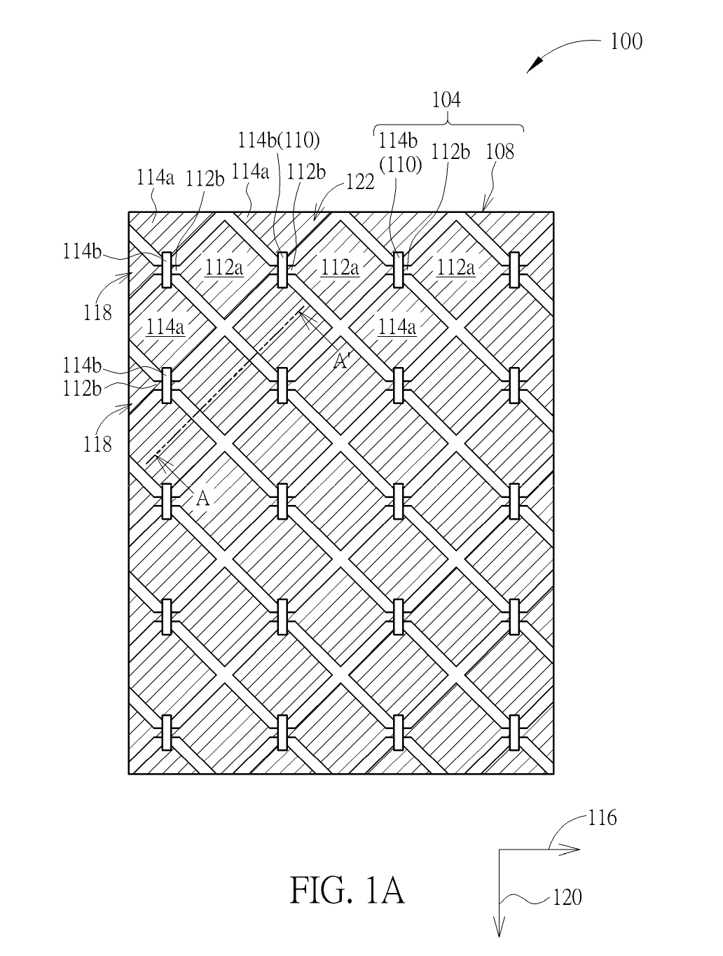

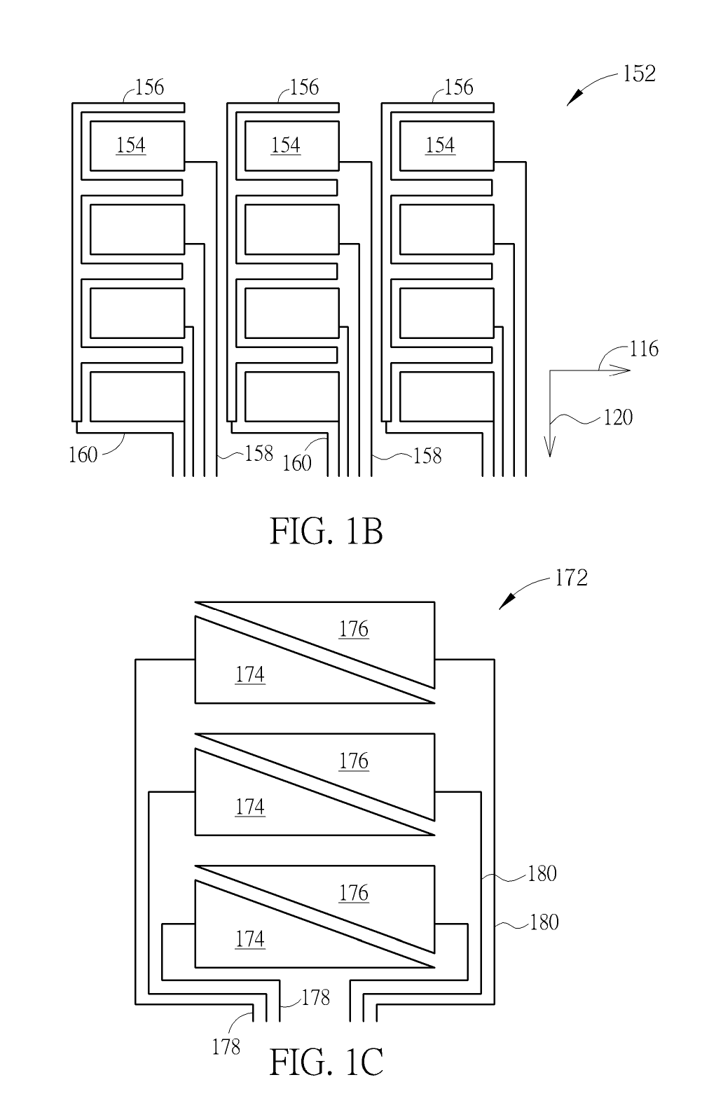

Referring to FIG. 1A and FIG. 2, FIG. 1A is a schematic top view illustrating the touch panel according to the first embodiment of the present invention, and FIG. 2 is a schematic cross-sectional view taken along the cross line A-A′ in FIG. LA. As shown in FIG. 1A and FIG. 2, the touch panel 100 of the present embodiment includes a substrate 102, a touch sensing device 104 and a first optical matching layer 106. The touch sensing device 104 is disposed on a side of the substrate 102 and is used to detect a touching object, such as a finger or a touch pen, by recognizing the position on the touch panel 100 which is being touched. The first optical matching layer 106 is disposed and covers a side of the substrate 102. In this embodiment, the substrate 102 is disposed between the touch sensing device 104 and the first optical matching layer 106. In other words, the touch sensing device 104 and the first matching layer 106 are disposed on two opposite sides of the substrate 102, but the present invention is not limited thereto. Also, the substrate 102 of this embodiment can be a transparent substrate, such as a glass substrate, a plastic substrate or a quartz substrate, but is not limited thereto.

In this embodiment, the touch sensing device 104 includes a first electrode pattern 108, a second electrode pattern 110 and an insulation layer (not shown in the drawings). For example, the first electrode pattern 108 is a transparent electrode pattern, but not limited thereto. Furthermore, the first electrode pattern 108 may include a plurality of first electrodes 112a, a plurality of first connection electrodes 112b and a plurality of second electrodes 114a. Each of the first connection electrodes 112b connects any two of the first electrodes 112a adjacent to each other and arranged along a first direction 116, so that the first electrodes 112a and the first connection electrodes 112b form a plurality of first electrode stripes 118 parallel to each other and extending along the first direction 116, and the first electrode stripes 118 are arranged along a second direction 120 sequentially. The second electrode pattern 110 includes a plurality of second connection electrodes 114b, wherein the second electrode pattern 110 may include metallic material or the same material as the first electrode pattern 108. Each of the second connection electrodes 114b crosses over each of the first connection electrodes 112b and connects any two of the second electrodes 114a adjacent to each other and arranged along the second direction 120, so that the second electrodes 114a and the second connection electrodes 114b form a plurality of second electrode stripes 122 parallel to each other and extending along the second direction 120, and the second electrode stripes are arranged along the first direction 116 sequentially. The insulation layer is disposed between the first connection electrodes 112b and the second connection electrodes 114b, so that the first electrode stripes 118 can cross the second electrode stripes 122 and are electrically isolated from each other through the insulation layer. For example, the insulation layer is patterned as multiple insulation segments and each of the insulation segments is arranged between one of the first connection electrodes 112b and the corresponding second connection electrode 114b (not shown in FIG. 1A). Moreover, the insulation layer can entirely cover the first electrode pattern 108 and the substrate 102 or extend along the first electrode pattern 108 to cover the first electrode pattern 108, optionally. Also, the portion of the insulation layer corresponding to each of the second electrodes 114a has an insulation hole (not shown in the drawings) exposing a part of each of the second electrodes 114a, so that each of the second connection electrodes 114b may cross over each of the first connection electrodes 112b to connect any two of the second electrodes 114a adjacent to each other and arranged along the second direction 120, thereby making each of the first electrode stripes 118 crossing over each of the second electrode strips 122 and being electrically isolated from each other through the insulation layer. Therefore, the position of the touching object can be recognized by detecting the touching object through the first electrode stripes 118 and the second electrode stripes 122. In this embodiment, the first direction 116 is perpendicular to the second direction 120, but is not limited thereto. It is worth mentioning that there is a first gap G1 between each of the first electrodes 112a and one of the second electrodes 114a adjacent thereto. In other words, the first electrode pattern 108 of this embodiment includes a plurality of first gaps G1 between the first electrodes 112a and the second electrodes 114a adjacent to the first electrodes 112a respectively.

Additionally, the first electrode pattern 108 and the second electrode pattern 110 in this embodiment may include silver or silver alloy respectively. For example, the first electrode pattern 108 and the second electrode pattern 110 maybe constituted by the same stack structure, but is not limited thereto. The first electrode pattern and the second electrode pattern of the present invention can also be constituted by different stack structures. Also, the first electrode pattern 108 and the second electrode pattern 110 may include a first transparent conductive layer 124, a first metal layer 126 and a second transparent conductive layer 128, respectively, and the first transparent conductive layer 124, the first metal layer 126 and the second transparent conductive layer 128 are stacked on the substrate 102 sequentially. The first transparent conductive layer 124 and the second transparent conductive layer 128 include transparent oxide-semiconductor material respectively, such as indium tin oxide (ITO), indium zinc oxide (IZO), aluminum tin (ATO) or aluminum zinc oxide (AZO), but the present invention is not limited thereto. The refractive index of the first transparent conductive layer 124 is substantially between 1.7 and 2.3, and the thickness of the first transparent conductive layer 124 is substantially between 15 and 80 nanometers (nm). The refractive index of the second transparent conductive layer 128 is substantially between 1.7 and 2.3, and the thickness of the second transparent conductive layer 128 is substantially between 15 and 80 nanometers (nm), but not limited thereto. The aforementioned refractive index is defined as the refractive index while the wavelength of the incident light is approximately 550 nanometers, but not limited thereto. Also, the first metal layer 126 includes silver or silver alloy, to increase the conductivity of the first electrode pattern 108 and to reduce the thickness of the first transparent conductive layer 124 and the second transparent conductive layer 128. Preferably, the silver alloy can include palladium or palladium-copper alloy, so that, the first metal layer 126 may obtain antioxidant property. The thickness of the first metal layer 126 is substantially between 5 and 25 nanometers, but not limited thereto. In other embodiments of the present invention, the first transparent conductive layer and the second transparent conductive layer can also be transparent dielectric films. In other words, the first electrode pattern may include the transparent dielectric film, the first metal layer and the transparent dielectric film stacked on the substrate sequentially, and the refractive index of the transparent dielectric film may be substantially between 1.7 and 2.3. Otherwise, the first electrode pattern may include the transparent conductive layer, the first metal layer and the transparent dielectric film stacked on the substrate sequentially, and the refractive index of the transparent conductive layer may be substantially between 1.7 and 2.3.

In this embodiment, the first optically matching layer 106 covers the first electrode pattern 108 and the first gaps G1, thereby overlapping the first electrode pattern 108 and the first gaps G1 in a projection direction perpendicular to the substrate 102, and the refractive index of the first optical matching layer 106 may be substantially between 1.6 and 1.8. With such arrangement, the first optical matching layer 106 can be used to reduce the color differences between light penetrating through the first electrode pattern 108 and light penetrating the first gaps G1, and the thickness of the first optical matching layer 106 is substantially between 5 and 100 nanometers. The first optical matching layer 106 of the present embodiment may include alumina (Al₂O₃), aluminum oxynitride (AlOₓN_{y}), silicon oxynitride (SiOₓN_{y}), yttrium oxide (Y₂O₃), ytterbium oxide (Yb₂O₃), magnesium oxide (MgO), holmium fluoride (HoF₃), beryllium oxide (BeO) or cerium fluoride (CeF₃), but not limited thereto.

TABLE 1

| | Reflected | Penetrating |
|---|---|---|
| | light | light |
| X-axis value of CIE 1931 | 0.341 | 0.329 |
| color space | | |
| Y-axis value of CIE 1931 | 0.302 | 0.334 |
| color space | | |
| Brightness ratio (%) | 7.07 | 86.41 |

TABLE 2

| | Reflected | Penetrating |
|---|---|---|
| | light | light |
| X-axis value of CIE 1931 | 0.327 | 0.334 |
| color space | | |
| Y-axis value of CIE 1931 | 0.329 | 0.334 |
| color space | | |
| Brightness ratio (%) | 10.45 | 89.55 |

TABLE 3

| | Reflected | Penetrating |
|---|---|---|
| | light | light |
| X-axis value of CIE 1931 | 0.357 | 0.328 |
| color space | | |
| Y-axis value of CIE 1931 | 0.295 | 0.333 |
| color space | | |
| Brightness ratio of light | 4.62 | 88.67 |
| (%) | | |

TABLE 4

| | Reflected | Penetrating |
|---|---|---|
| | light | light |
| X-axis value of CIE 1931 | 0.333 | 0.333 |
| color space | | |
| Y-axis value of CIE 1931 | 0.333 | 0.333 |
| color space | | |
| Brightness ratio of light | 8.17 | 91.83 |
| (%) | | |

In the following, the color differences and the brightness differences between the portion of the touch panel 100 corresponding to the first electrode pattern 108 and the portion of the touch panel 100 corresponding to the first gaps G1, which are measured when the white light is irradiated to the touch panel 100 of the present embodiment and a touch panel without the first optical matching layer, is further described. Referring to TABLEs 1-4, TABLE 1 represents the color and the brightness of the light when the light passes through the portion of the touch panel 100 corresponding to the first electrode pattern 108 in the present embodiment, and the color and the brightness of the light when the light is reflected by the portion of the touch panel 100 corresponding to the first electrode pattern 108 in the present embodiment. TABLE 2 represents the color and the brightness of the light when the light passes through the portion of the touch panel 100 corresponding to the first gaps G1, and the color and the brightness of the light when the light is reflected by the portion of the touch panel 100 corresponding to the first gaps G1. TABLE 3 represents the color and the brightness of the light when the light passes through the portion of the touch panel without the first optical matching layer, which is corresponding to the first electrode pattern, and the color and the brightness of the light when the light is reflected by the portion of the touch panel without the first optical matching layer, which is corresponding to the first electrode pattern. TABLE 4 represents the color and the brightness of the light when the light passes through the portion of the touch panel without the first optical matching layer, which is corresponding to the first gaps, and the color and the brightness of the light when the light is reflected by the portion of the touch panel without the first optical matching layer, which is corresponding to the first gaps. In view of TABLEs 1-4, it is note that while the light passes through the touch panel, the color differences and the brightness differences between the portion of touch panel 100 corresponding to the first electrode pattern 108 and the portion of the touch panel 100 corresponding to the first gaps G1 in the present embodiment are less than the color differences and the brightness differences between the portion of touch panel without the first optical matching layer, corresponding to the first electrode pattern, and the portion of the touch panel without the first optical matching layer, corresponding to the first gaps respectively. On the other hand, while the light is reflected by the touch panel, the color differences and the brightness differences between the portion of touch panel 100 corresponding to the first electrode pattern 108 and the portion of the touch panel corresponding to the first gaps G1 in the present embodiment is less than the color differences and the brightness differences between the portion of touch panel without the first optical matching layer, corresponding to the first electrode pattern, and the portion of the touch panel without the first optical matching layer, corresponding to the first gaps, respectively. It is known that, through disposing the optical matching layer 106 to cover a side of the substrate 102, the touch panel 100 of the present embodiment may effectively reduce the color differences and the brightness differences between the portion thereof corresponding to the first electrode pattern 108 and the portion thereof corresponding to the first gaps G1, so as to obtain uniform light transmittance accordingly. With such, the visibility of the touch sensing device 104 can be significantly reduced, and the touch sensing device 104 is no longer to easily be seen and recognized by the user.

The touch panel of the present invention is not limited to the aforementioned embodiments. The following description will detail other embodiments or variants of the touch panel of the present invention. To simplify the description, the following description only details the differences between those embodiments or the variants and the above-mentioned embodiment. The same numerals denote the same components, and the identical features will not be redundantly described.

Referring to FIG. 1B and 1C, FIG. 1B and FIG. 1C are schematic top views illustrating different variants of the touch sensing device according to the first embodiment of the present invention. As shown in FIG. 1B, in comparison with the aforementioned embodiment, the touch sensing device of this variant does not include the electrode pattern. In other words, the touch sensing device is only consisted of a single layer of the first electrode pattern 152, and does not include the second electrode pattern. The function of detecting touching position can be achieved by utilizing the configuration and the wiring design of the first electrode pattern 152. Furthermore, the first electrode pattern 152 of the present variant includes a plurality of first electrodes 154, a plurality of second electrodes 156, a plurality of first wirings 158 and a plurality of second wirings 160. The first electrodes 154 are arranged in an array arrangement, such as in a rectangle shape, but not limited thereto. Each of the second electrodes 156 is disposed at a side of the first electrodes 154 in the same column, and opposite to the first electrodes 154 disposed in the same column, and each of the second electrodes 156 extends to a portion between any two of the first electrodes 154 adjacent to each other in the same column, namely, being arranged along the second direction 120 and between any two of the first electrodes 154 adjacent to each other, thereby making each of the second electrodes 156 being in palisade shaped, but not limited thereto. Also, each of the first electrodes 154 is electrically connected to each of the first wirings 158 and further electrically connected to external through the first wirings 158; and each of the second electrodes 156 is electrically connected to each of the second wirings 160, and further electrically connected to external through the second wirings 150. In other embodiments of the present invention, each of the second electrodes may be disposed at the same side of the first electrodes in the same row, and extends to a portion between any two of the first electrodes adjacent to each other in the same row. Moreover, the first wirings and the second wirings can also be formed from different conductive materials in comparison with the first electrode pattern.

In addition, as shown in FIG. 1C, in comparison with aforementioned embodiments, the touch sensing device of the present variant does not include the electrode pattern either, and is only consisted of a single layer of the first electrode pattern 172 and does not include the second electrode pattern. Also, the first electrode pattern 172 of the present variant includes a plurality of first electrodes 174, a plurality of second electrodes 176, a plurality of first wirings 178 and a plurality of second wirings 180. Each of the first electrodes 174 is opposite to each of the second electrodes 176 to compose an electrode pair 182, and the plurality of the electrode pairs 182 are arranged in an array arrangement. Each of the first electrodes 174 is electrically connected to each of the first wirings 178 and further electrically connected to external through the first wirings 178, and each of the second electrodes 176 is electrically connected to each of the second wirings 180 and further electrically connected to external through the second wirings 180. In other embodiments of the present invention, the first wiring and the second wiring can also be formed by different conductive materials.

Referring to FIG. 3, FIG. 3 is a schematic cross-sectional view illustrating another variant of the touch panel according to the first embodiment of the present invention. As shown in FIG. 3, in comparison with the aforementioned first embodiment, the first electrode pattern 108 of the touch panel 100 of the present variant may not include the second transparent conductive layer, and is only consisted of the first transparent conductive layer 124 and the first metal layer 126. Also, the first transparent conductive layer 124 and the first metal layer 126 are disposed on the substrate 102 sequentially. In other embodiments of the present invention, the first transparent conductive layer can also be transparent dielectric film. In other words, the first electrode pattern may include the transparent dielectric film and the first metal layer stacked sequentially on the substrate, and the refractive index of the transparent dielectric film may be substantially between 1.7 and 2.3.

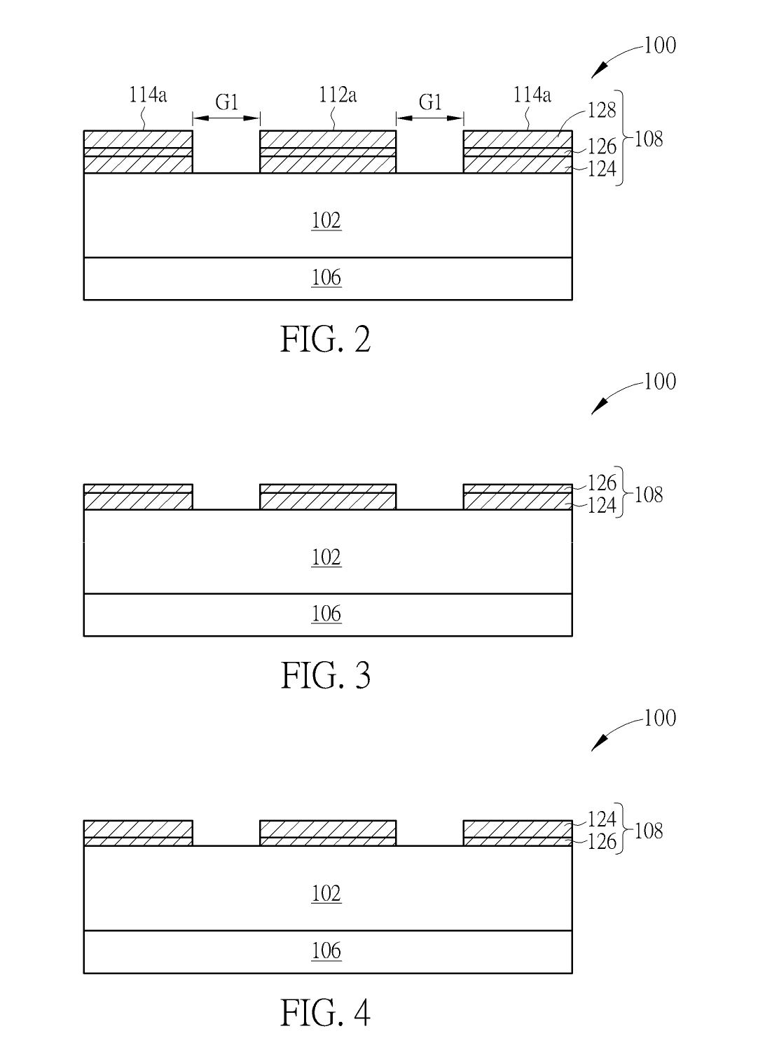

Referring to FIG. 4, FIG. 4 is a schematic cross-sectional view illustrating another variant of the touch panel according to the first embodiment of the present invention. As shown in FIG. 4, in comparison with the aforementioned first embodiment, the first electrode pattern 108 of the touch panel 100 of the present variant may not include the second transparent conductive layer either, and is only consisted of the first transparent conductive layer 124 and the first metal layer 126. Also, the first metal layer 126 and the first transparent conductive layer 124 are disposed on the substrate 102 sequentially. In other embodiments of the present invention, the first transparent conductive layer can also be a transparent dielectric film. In other words, the first electrode pattern may include the first metal layer and the transparent dielectric film stacked sequentially on the substrate, and the refractive index of the transparent dielectric film may be substantially between 1.7 and 2.3.

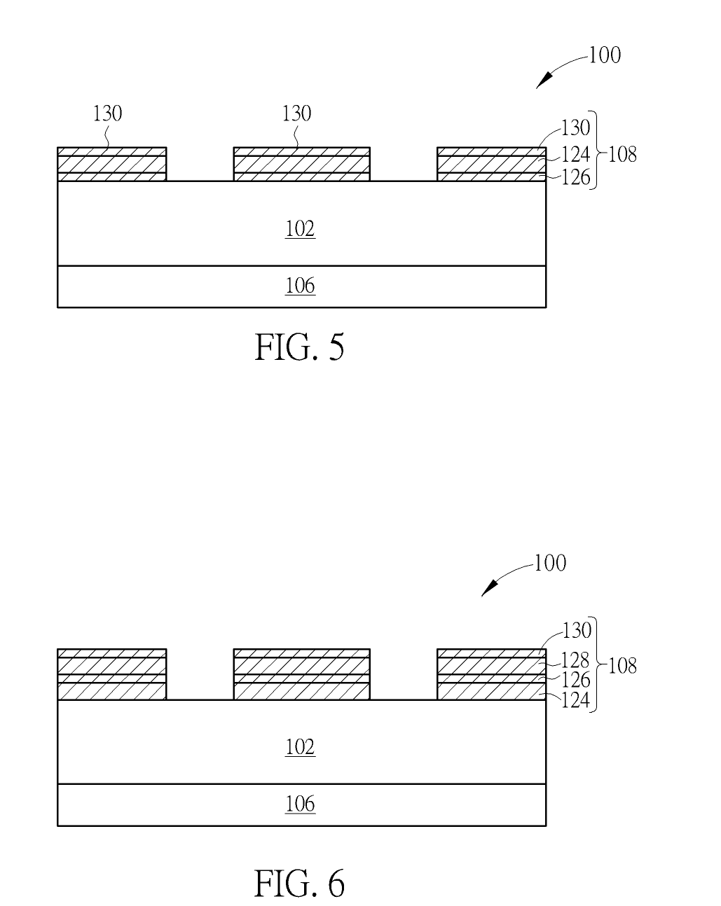

Referring to FIG. 5, FIG. 5 is a schematic cross-sectional view illustrating another variant of the touch panel according to the first embodiment of the present invention. As shown in FIG. 5, in comparison with the aforementioned first embodiment, the first electrode pattern 108 of the touch panel 100 of the present variant may not include the second transparent conductive layer, and further includes a second metal layer 130. Also, the first transparent conductive layer 124 is disposed between the first metal layer 126 and the second metal layer 130, and the first metal layer 126, the first transparent conductive layer 124 and the second metal layer 130 are disposed on the substrate 102 sequentially. The second metal layer 130 may include silver or silver alloy, and preferably, the silver alloy may include palladium or palladium-copper alloy, so that the second metal layer 130 may have antioxidant property. The thickness of the second metal layer 130 may substantially be between 5 and 25 nanometers.

Referring to FIG. 6, FIG. 6 is a schematic cross-sectional view illustrating another variant of the touch panel according to the first embodiment of the present invention. As shown in FIG. 6, in comparison with the aforementioned first embodiment, the first electrode pattern 108 of the touch panel 100 of the present variant may further include a second metal layer 130, and the second transparent conductive layer 128 is disposed between the first metal layer 126 and the second metal layer 130. For example, the first transparent conductive layer 124, the first metal layer 126, the second transparent conductive layer 128 and the second metal layer 130 are disposed on the substrate 102 sequentially, but not limited thereto. In other embodiments of the present invention, the second metal layer, the second transparent conductive layer, the first metal layer and the first transparent conductive layer may be disposed on the substrate sequentially.

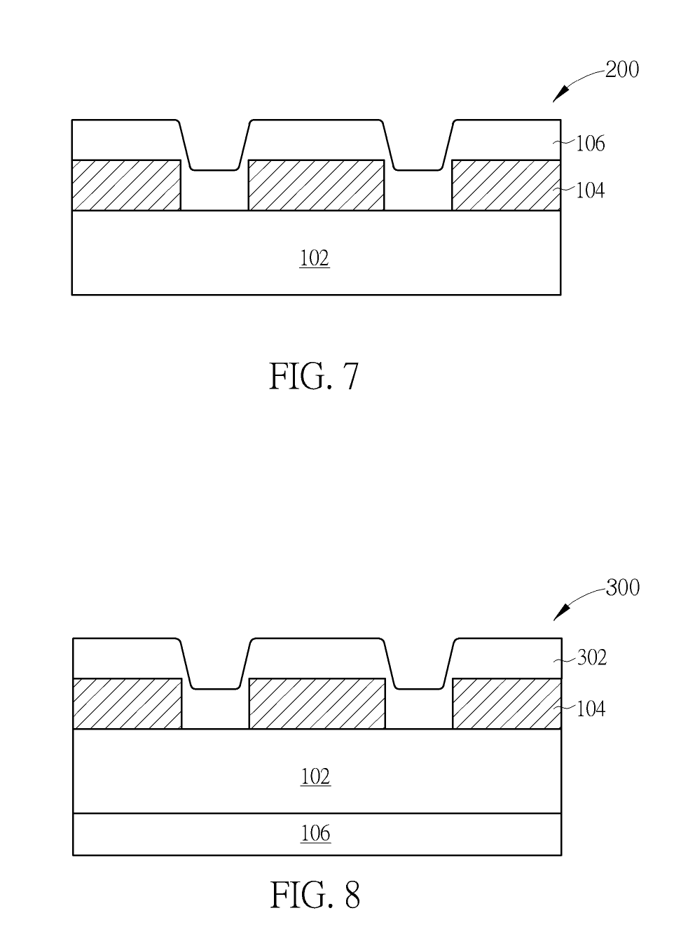

Referring to FIG. 7, FIG. 7 is a schematic cross-sectional view illustrating a touch panel according to a second embodiment of the present invention. As shown in FIG. 7, in comparison with the aforementioned first embodiment, the touch sensing device 104 and the first optical matching layer 106 of the touch panel 200 in the present embodiment is disposed on the same side of the substrate 102. For example, the touch sensing device 104 can be disposed between the first optical matching layer 106 and the substrate 102, with the first optical matching layer 106 being disposed on the touch sensing device 104 to protect the touch sensing device 104, but not limited thereto. In other words, the touch sensing device 104 can be primarily formed on the substrate 102, and then the first optical matching layer 106 is formed on the touch sensing device 104 and the substrate 102 through a chemical vapor deposition (CVD) process, such as atomic layer deposition (ALD), or a physical vapor deposition (PVD), such as sputtering process. In other embodiments of the present invention, the first optical matching layer may also be disposed between the touch sensing device and the substrate, or functions as an insulation layer of the touch sensing device. Additionally, the touch sensing device can be any one of the aforementioned variants of the touch sensing devices shown in FIG. 1B, FIG. 1C, and FIGS. 3-6.

Referring to FIG. 8, FIG. 8 is a schematic cross-sectional view illustrating a touch panel according to a third embodiment of the present invention. As shown in FIG. 8, in comparison with the aforementioned first embodiment, the touch panel 300 of the present embodiment further includes a second optical matching layer 302 disposed on and covering the substrate 102, and the substrate 102 is disposed between the first optical matching layer 106 and the second optical matching layer 302. For example, the second optical matching layer 302 and the touch sensing device 104 are disposed on the same side of the substrate 102, with the touch sensing device 104 being disposed between the first optical matching layer 106 and the second optical matching layer 302, and the second optical matching layer 302 is disposed on the touch sensing device 104, for protecting the touch sensing device 104, but not limited thereto. In other words, the touch sensing device 104 may be primarily formed on the substrate 102, and then the first optical matching layer 106 and the second optical matching layer 302 are formed on two opposite sides of the substrate 102 through a chemical vapor deposition (CVD) process, such as atomic layer deposition (ALD), or a physical vapor deposition (PVD), such as sputtering process. In other embodiments of the present invention, the second optical matching layer may also be disposed between the touch sensing device and the substrate, or functions as an insulation layer of the touch sensing device. Additionally, the touch sensing device can be any aforementioned variant type of the touch sensing devices shown in FIG. 1B, FIG. 1C, and FIGS. 3-6.

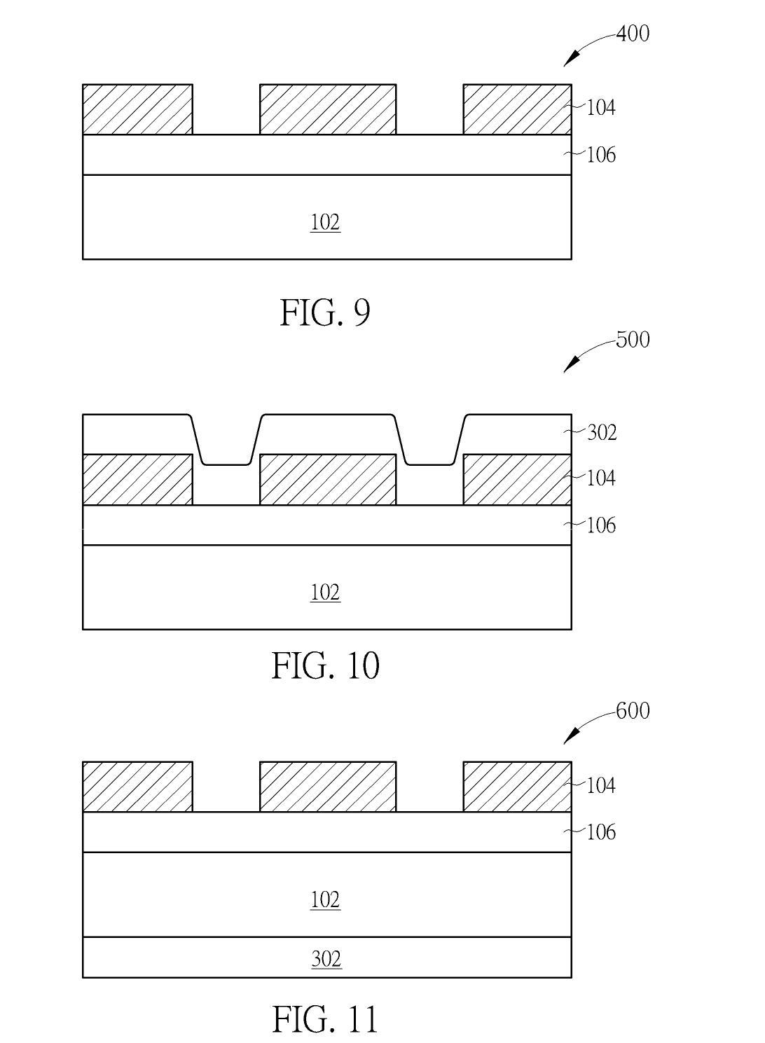

Referring to FIG. 9, FIG. 9 is a schematic cross-sectional view illustrating a touch panel according to a fourth embodiment of the present invention. As shown in FIG. 9, in comparison with the aforementioned first embodiment, the touch sensing device 104 and the first optical matching layer 106 of the touch panel 400 in the present embodiment are disposed on the same side of the substrate 102, and the first optical matching layer 106 is disposed between the touch sensing device 104 and the substrate 102. In other embodiments of the present invention, the touch sensing device can be any one of the aforementioned variants of the touch sensing devices shown in FIG. 1B, FIG. 1C, and FIGS. 3-6.

Referring to FIG. 10, FIG. 10 is a schematic cross-sectional view illustrating a touch panel according to a fifth embodiment of the present invention. As shown in FIG. 10, in comparison with the aforementioned third embodiment, the touch sensing device 104, the first optical matching layer 106 and the second optical matching layer 302 of the touch panel 500 in the present embodiment are disposed on the same side of the substrate 102, and the touch sensing device 104 is disposed between the first optical matching layer 106 and the second optical matching layer 302, with the first optical matching layer 106, touch sensing device 104 and the second optical matching layer 302 being stacked on the substrate 102 sequentially. In other embodiments of the present invention, the touch sensing device can be anyone of the aforementioned variants of the touch sensing devices shown in FIG. 1B, FIG. 1C, and FIGS. 3-6.

Referring to FIG. 11, FIG. 11 is a schematic cross-sectional view illustrating a touch panel according to a sixth embodiment of the present invention. As shown in FIG. 11, in comparison with the aforementioned third embodiment, the second optical matching layer 302 of the touch panel 600 in the present embodiment is disposed between the touch sensing device 104 and the substrate 102, and the substrate 102 is disposed between the first optical matching layer 106 and the second optical matching layer 302. In other embodiments of the present invention, the touch sensing device can be any aforementioned variant type of the touch sensing devices shown in FIG. 1B, FIG. 1C, and FIGS. 3-6.

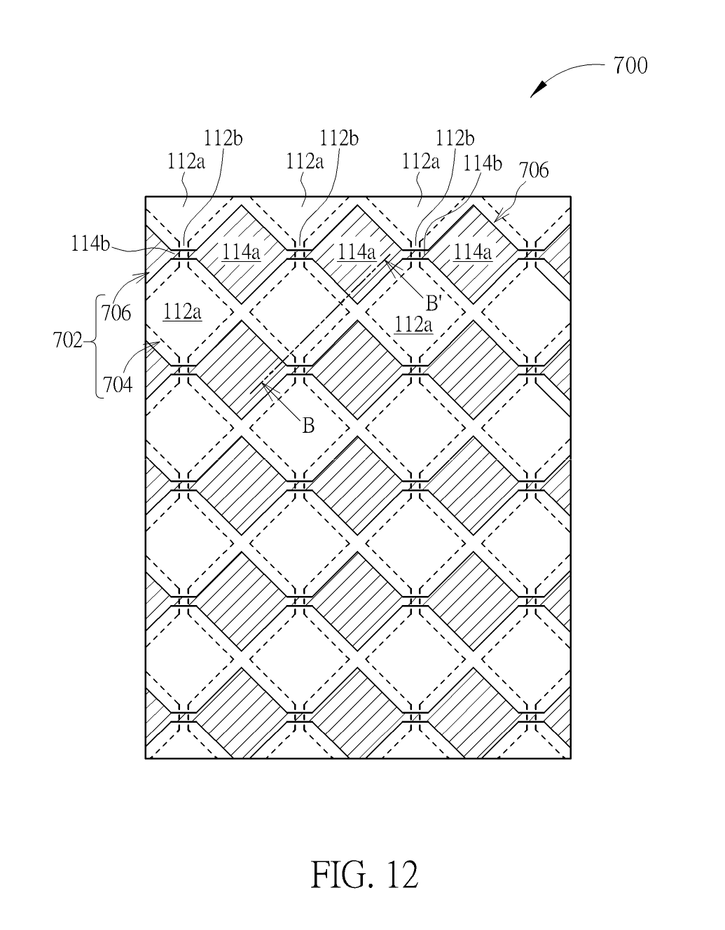

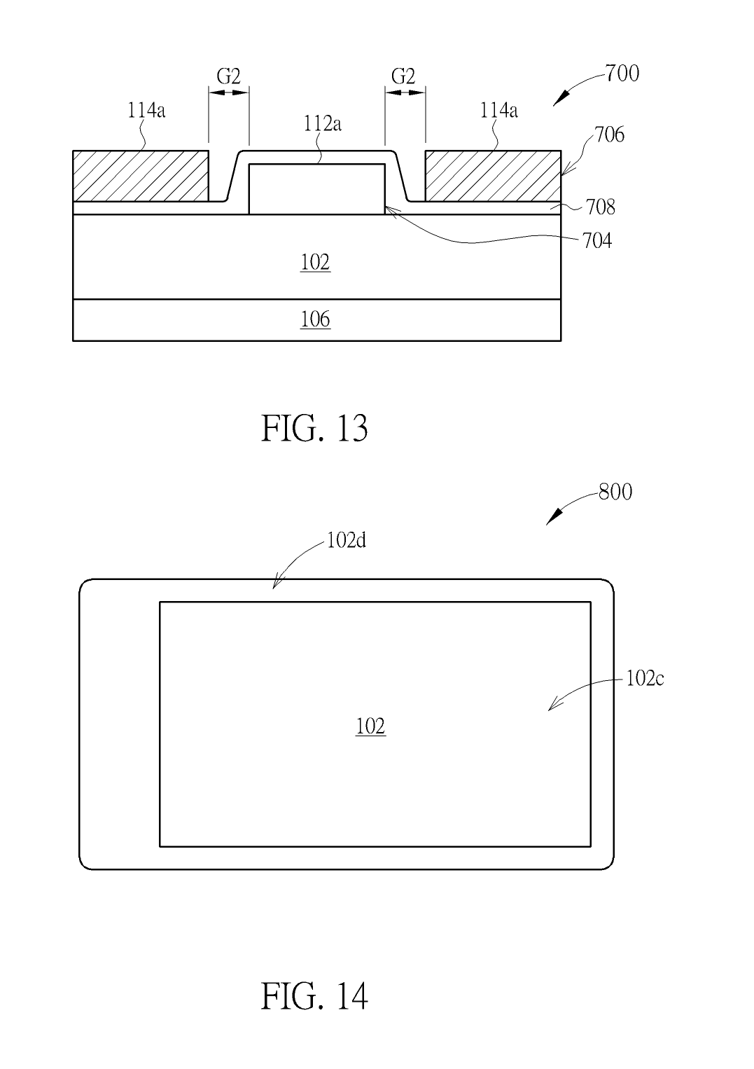

Referring to FIG. 12 and FIG. 13, FIG. 12 is a schematic cross-sectional view illustrating a touch panel according to a seventh embodiment of the present invention, and FIG. 13 is a schematic cross-sectional view taken along a cross line B-B′ in FIG. 12. As shown in FIG. 12 and FIG. 13, in comparison with the aforementioned first embodiment, the first electrodes 112a and the second electrodes 114a of the touch panel 700 in the present embodiment are formed by different electrode patterns. In other words, in the present embodiment, the touch sensing device 702 includes a first electrode pattern 704, a second electrode pattern 706 and an insulation layer 708, wherein the first electrode pattern 704 includes a plurality of first electrodes 112a and a plurality of first connection electrodes 112b, and the second electrode pattern 706 includes a plurality of second electrodes 114a and a plurality of second connection electrodes 114b. Also, the insulation layer 708 is disposed between the first electrode pattern 704 and the second electrode pattern 706. Please note that, there is a plurality of second gaps G2 between the first electrodes 112a and the second electrodes 114a in the present embodiment. Namely, the second gaps G2 are formed between the first electrode pattern 704 and the second electrode pattern 706 adjacent to the first electrode pattern 704 in the projection direction perpendicular to the substrate 102, and the first optical matching layer 106 covers the first electrode pattern 704, the second electrode pattern 706 and the second gaps G2, so as to overlap the first electrode pattern 704, the second electrode pattern 706 and the second gaps G2 in the projection direction. In the present embodiment, the first electrode pattern 704 is a transparent electrode pattern, and the second electrode pattern 706 is a transparent electrode pattern either, but the present invention is not limited thereto. Furthermore, the second electrode pattern 706 and the first electrode pattern 704 may include the same stack structure, but the present invention is not limited thereto. In other embodiments of the present invention, the first electrode pattern and the second electrode pattern may also include any one of the aforementioned variants of the stack structure of the first electrode pattern.

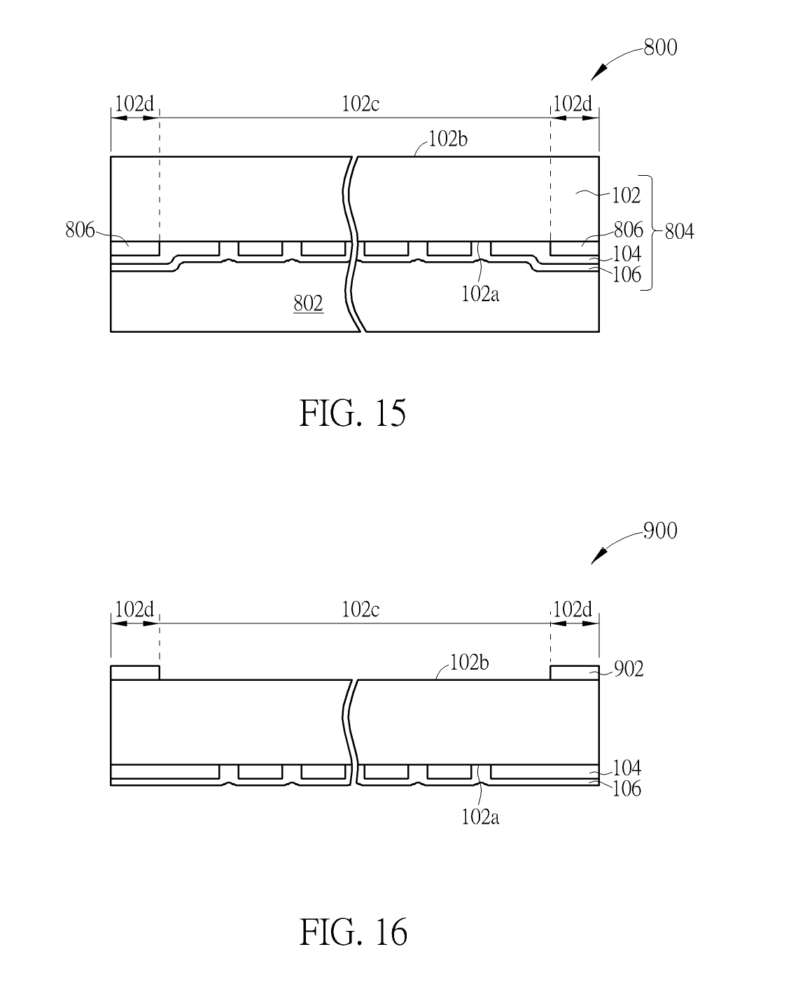

Referring to FIG. 14 and FIG. 15, FIG. 14 is a schematic top view illustrating the touch display panel according to an eighth embodiment of the present invention, and FIG. 15 is a schematic cross-sectional view illustrating the touch display panel according to the eighth embodiment of the present invention. As shown in FIG. 14 and FIG. 15, the eighth embodiment of the present invention provides a touch display panel 800, including a display panel 802 and a touch panel 804. The difference between the touch panel 804 of the present embodiment and the touch panel of the aforementioned second embodiment is that the substrate 102 of the touch panel 804 in the present invention may function as a cover lens, and the substrate 102 is disposed on the display panel 802. In other words, the touch sensing device 104 of the touch panel 804 is disposed on the side of the substrate 102 facing the display panel 802, namely, the inner surface 102a of the substrate 102. Accordingly, in practical operation, the touch sensing device 104 is disposed on the inner surface 102a of the substrate 102, and the user will touch on the outer surface 102b of the substrate. Moreover, precisely speaking, the substrate 102 includes a touching region 102c and a periphery region 102d disposed at at least one side of the touching region 102c, and the touch sensing device 104 is disposed in the touching region 102c. Furthermore, the first optical matching layer 106 of the present embodiment is disposed on the side of the substrate 102 facing the display panel 802, and between the touch sensing device 104 and the display panel 802, but not limited thereto. In other embodiments of the present invention, the touch sensing device and the first optical matching layer can be arranged according to the configuration of the touch sensing device and the optical matching layer of the touch panel in any variant of the aforementioned first embodiment or in the third embodiment to the seventh embodiment, and the touch sensing device can include the structure of the touch sensing device in any variant of the aforementioned first embodiment or in the third embodiment to the seventh embodiment. Also, the touch panel may further include a second optical matching layer, as illustrated in the touch panel of the third embodiment and the seventh embodiment.

Additionally, the touch panel 804 of the present embodiment further includes a decoration layer 806, disposed within the periphery region 102d. Precisely, the decoration layer 806 for example may be used to shield the wirings and other elements (not shown in the drawings) disposed within the periphery region 102d. Also, the decoration layer 806 can be disposed on the side of the substrate 102 facing the display panel 802. In other words, the decoration layer 806 and the touch sensing device 104 are disposed on the same side of the substrate 102, namely on the inner surface 102a, and between the substrate 102 and the touch sensing device 104, but the present invention is not limited thereto. In other embodiments of the present invention, the touch sensing device can be optionally disposed in the periphery region according to practical requirement.

Referring to FIG. 16, FIG. 16 is a schematic cross-sectional view illustrating the touch panel according to the ninth embodiment of the present invention. As shown in FIG. 9, the difference between the touch panel 900 of the present embodiment and the touch panel of the aforementioned eighth embodiment is that the decoration layer 902 and the touch sensing device 104 are disposed on two opposite sides of the substrate 102 respectively. In other words, the decoration layer 902 is disposed on the outer surface 102b of the substrate 102, namely, the surface adapted to be touched by the user.

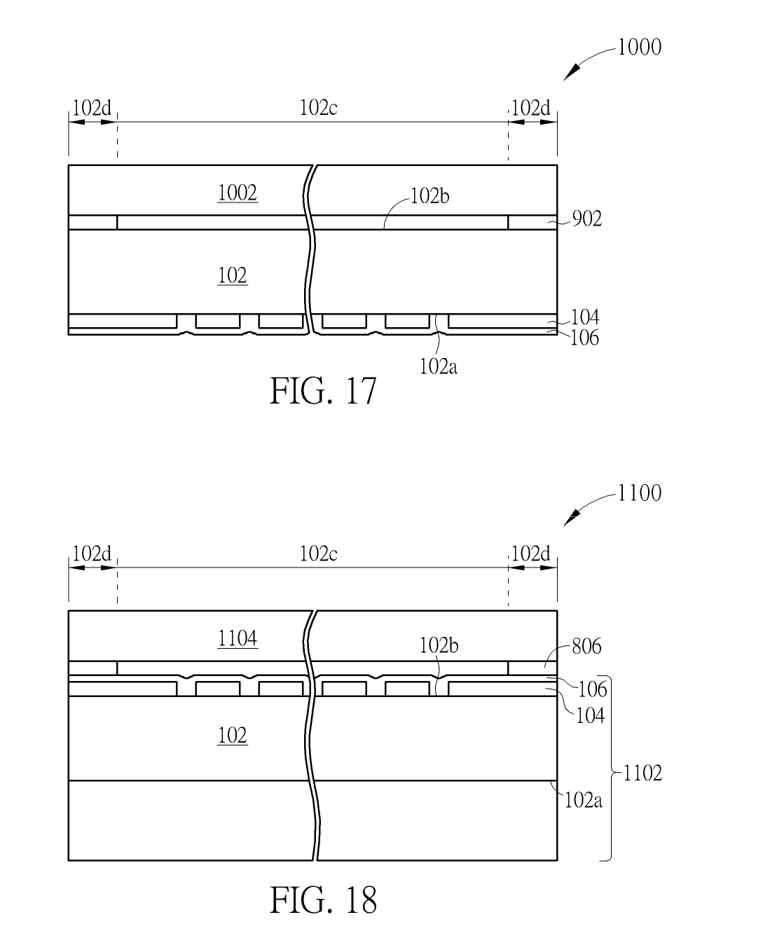

Referring to FIG. 17, FIG. 17 is a schematic cross-sectional view illustrating the touch display panel according to a tenth embodiment of the present invention. As shown in FIG. 17, the difference between the touch panel 1000 of the present embodiment and the touch panel of the aforementioned ninth embodiment is that the touch panel 1000 of the present embodiment further includes a carrier substrate 1002, disposed and attached on the outer surface 102b of the substrate 102. Also, the decoration layer 902 of the present embodiment is disposed on the side of the carrier substrate 1002 facing the substrate 102, and corresponding to the periphery region 102d of the substrate 102.

Referring to FIG. 18, FIG. 18 is a schematic top view illustrating the touch display panel according to an eleventh embodiment of the present invention. As shown in FIG. 18, the eleventh embodiment of the present invention provides a touch display panel 1100. In comparison with the touch display panel of aforementioned eighth embodiment, in the present embodiment, the substrate 102 having the touch sensing device disposed thereon can also be used as a substrate of the display panel 802, thereby integrating the touch sensing device 104 in the display panel 1102. In other words, the touch display panel 1100 includes the display panel 1102, and the display panel 1102 includes the substrate 102, touch sensing device 104 and a first optical matching layer 106, wherein the touch sensing device 104 is disposed on the outer surface 102b of the substrate 102 and the first optical matching layer 106 is disposed on the outer surface 102b of the substrate 102. Also, the touch sensing device 104 is disposed between the first optical matching layer 106 and the substrate 102. Furthermore, the touch display panel 1100 of the present embodiment may optionally include a cover lens 1104. Wherein the cover lens 1104 is disposed and attached on the outer surface 102b of the substrate 102, with the cover lens 1104 being disposed on the side of the substrate having the touch sensing device 104, and the touch sensing device 104 is dispose between the substrate 102 and the cover lens 1104. Further, the touch display panel 1100 of the present embodiment may optionally include a decoration layer 806, disposed on the side of the cover lens 1104 facing the touch sensing device 104, and corresponding to the periphery region 102d of the substrate 102. In other embodiments of the present invention, the touch sensing device and the first optical matching layer can be arranged according to the configuration of the touch sensing device and the optical matching layer of the touch panel in any variant of the aforementioned first embodiment or in the third embodiment to the seventh embodiment, and the touch sensing device can include the structure of the touch sensing device in any variant type of the aforementioned first embodiment or in the third embodiment to the seventh embodiment.

In summary, through disposing the optical matching layer on at least a side of the substrate, the color differences and brightness differences between the portion of the touch panel corresponding to the electrode pattern and the portion of the touch panel corresponding to the gap can be effectively reduced in the touch panel of the present invention, so as to obtain uniform light transmittance accordingly. With such, the visibility of the touch sensing device can be significantly reduced, and the touch sensing device is no longer to easily be seen and recognized by the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate;
a touch sensing device, disposed on the substrate, and the touch sensing device comprising a first electrode pattern; and
a first optical matching layer, disposed on the substrate.

2. The touch panel according to claim 1, wherein the substrate is disposed between the touch sensing device and the first optical matching layer.

3. The touch panel according to claim 1, wherein the touch sensing device is disposed between the first optical matching layer and the substrate.

4. The touch panel according to claim 3, further comprising a second optical matching layer disposed on the substrate, and the substrate being disposed between the first optical matching layer and the second optical matching layer.

5. The touch panel according to claim 1, wherein the first optical matching layer is disposed between the touch sensing device and the substrate.

6. The touch panel according to claim 5, further comprising a second optical matching layer, disposed on the substrate, and the substrate being disposed between the first optical matching layer and the second optical matching layer.

7. The touch panel according to claim 5, further comprising a second optical matching layer, disposed on the substrate, and the touch sensing device being disposed between the first optical matching layer and the second optical matching layer.

8. The touch panel according to claim 1, wherein a refractive index of the first optical matching layer is between 1.6 and 1.8.

9. The touch panel according to claim 1, wherein a thickness of the first optical matching layer is between 5 nanometers and 100 nanometers.

10. The touch panel according to claim 1, wherein the first optical matching layer comprises alumina (Al₂O₃), aluminum oxynitride (AlOₓN_{y}), silicon oxynitride (SiOₓN_{y}), yttrium oxide (Y₂O₃), ytterbium oxide (Yb₂O₃), magnesium oxide (MgO), holmium fluoride (HoF₃), beryllium oxide (BeO) or cerium fluoride (CeF₃).

11. The touch panel according to claim 1, wherein the first electrode pattern comprises a transparent dielectric film and a first metal layer.

12. The touch panel according to claim 11, wherein a refractive index of the transparent dielectric film is between 1.7 and 2.3.

13. The touch panel according to claim 1, wherein the first electrode pattern comprises a first transparent conductive layer and a first metal layer.

14. The touch panel according to claim 13, wherein the first metal layer comprises silver or silver alloy.

15. The touch panel according to claim 14, wherein the silver alloy comprises palladium or palladium-copper alloy.

16. The touch panel according to claim 13, wherein a refractive index of the first transparent conductive layer is between 1.7 and 2.3.

17. The touch panel according to claim 13, wherein the first metal layer and the first transparent conductive layer are disposed on the substrate sequentially.

18. The touch panel according to claim 13, wherein the first transparent conductive layer and the first metal layer are disposed on the substrate sequentially.

19. The touch panel according to claim 13, wherein the first electrode pattern further comprises a second transparent conductive layer, and the first metal layer is disposed between the first transparent conductive layer and the second transparent conductive layer.

20. The touch panel according to claim 19, wherein the first electrode pattern further comprises a second metal layer, and the second transparent conductive layer is disposed between the first metal layer and the second metal layer.

21. The touch panel according to claim 13, wherein the first electrode pattern further comprises a second metal layer, and the first transparent conductive layer is disposed between the first metal layer and the second metal layer.

22. The touch panel according to claim 1, wherein the first electrode pattern has a plurality of first gaps, and the first optical matching layer covers the first electrode pattern and the first gaps.

23. The touch panel according to claim 1, wherein the touch sensing device further comprises a second electrode pattern, there is a plurality of second gaps between the first electrode pattern and the second electrode pattern, and the first optical matching layer covers the first electrode pattern, the second electrode pattern and the second gaps.

24. The touch panel according to claim 23, wherein the first electrode pattern is a transparent electrode pattern, and the second electrode pattern is a transparent electrode pattern.

25. The touch panel according to claim 1, wherein the first electrode pattern comprises silver or silver alloy.

26. The touch panel according to claim 1, wherein the substrate comprises a touching region and a periphery region disposed at at least one side of the touching region, the touch panel further comprises a decoration layer, and the decoration layer is disposed in the periphery region.

27. The touch panel according to claim 26, wherein the decoration layer is disposed on the substrate, and decoration layer and the touch sensing device are disposed at a same side of the substrate.

28. The touch panel according to claim 26, wherein the decoration layer is disposed on the substrate, and decoration layer and the touch sensing device are disposed at two opposite sides of the substrate.

29. The touch panel according to claim 26, further comprising a carrier substrate disposed on the substrate, and the decoration layer is disposed at a side of the carrier substrate facing the substrate.

30. A touch panel, comprising:
a substrate;
a touch sensing device, disposed on the substrate, and the touch sensing device comprising a first electrode pattern;
a first optical matching layer, disposed on the substrate; and
a second optical matching layer, disposed on the substrate, wherein the touch sensing device being disposed between the first optical matching layer and the second optical matching layer.

31. The touch panel according to claim 30, wherein the touch sensing device further comprises a second electrode pattern.

32. The touch panel according to claim 30, wherein the substrate comprises a touching region and a periphery region disposed at at least one side of the touching region, the touch panel further comprises a decoration layer, and the decoration layer is disposed in the periphery region.

33. The touch panel according to claim 32, wherein the decoration layer is disposed on the substrate, and decoration layer and the touch sensing device are disposed at a same side of the substrate.

34. The touch panel according to claim 32, wherein the decoration layer is disposed on the substrate, and decoration layer and the touch sensing device are disposed at two opposite sides of the substrate.

35. The touch panel according to claim 32, further comprising a carrier substrate disposed on the substrate, and the decoration layer is disposed at a side of the carrier substrate facing the substrate.

36. A touch display panel, comprising:
a display panel, the display panel comprising;
a substrate;
a touch sensing device, disposed on the substrate, and the touch sensing device comprising a first electrode pattern; and
a first optical matching layer, disposed on the substrate.

37. The touch display panel according to claim 36, wherein the first electrode pattern comprises silver or silver alloy.

38. The touch display panel according to claim 36, further comprising:
a cover lens, disposed on a side of the substrate where the touch sensing device is disposed; and
a decoration layer, disposed at a side of the cover lens facing the touch sensing device and corresponding to a peripheral region of the substrate.
